(19) United States
(12) Patent Application Publication
(10) Pub. No.: US 2002/0026418 A1
(43) Pub. Date: Feb. 28, 2002

(54) METHOD FOR PROVIDING PRE-PAID ANONYMOUS ELECTRONIC DEBIT CARD COMPATIBLE WITH EXISTING NETWORK OF CREDIT CARDS

(76) Inventors: ADAM KOPPEL, PHILADELPHIA, PA (US); JAY OYAKAWA, LOS ANGELES, CA (US); JONATHAN GRILL, PHILADELPHIA, PA (US)

Correspondence Address: namesafe inc., 520 s. sepulveda blvd., suite 400, los angeles, CA, 90049, US

(21) Appl. No.: 09/346,317

(22) Filed: Jul. 2, 1999

(51) Int. Cl. G06F 17/60

(52) U.S. Cl. 705/41

(57) ABSTRACT

An issuer of pre-paid electronic debit cards contracts with an issuing bank for a main account compatible with an existing network of credit cards such as MasterCard or Visa, the main account being divided into sub-accounts. Upon pre-payment by a customer, the issuer issues to the customer a pre-paid electronic debit card, bearing the name of the issuer, for accessing one of the sub-accounts. The card can be issued in purely electronic form and is usable for electronic commerce as though it were the corresponding type of credit card. Purchases are billed to the main account. The customer can receive the card for personal use or send it to a third party, either as a gift or as payment for a purchase.

### BACKGROUND OF THE INVENTION

The present invention is directed to a method for providing anonymous, widely accepted electronic money for electronic commerce.

As electronic commerce, or e-commerce, has grown, so have concerns about paying for online purchases. Such concerns stem from the absence of a way to use cash in cyberspace.

For purchases from an online merchant, the usual form of payment is a major credit card such as MasterCard, Visa, American Express or Discover. The buyer provides the merchant with the card number, expiration date and name on the card through a secure server. However, many potential buyers are concerned about the potential for fraud through theft of that information. Also, buyers of “adult” merchandise often wish to buy anonymously; credit cards, unlike cash, do not offer that option.

In addition, persons who lack credit cards cannot do business with online merchants at all, regardless of whether they have enough cash on hand for any particular purchase. Many persons cannot qualify for credit cards; examples include minors, persons with insufficient annual incomes, and persons with bad credit or no credit. Others choose not to use credit cards because of concerns over financial discipline.

An online merchant can arrange with an Internet service provider (ISP) to use that ISP's billing mechanism to pay for purchases. However, such billing works only when the merchant and the buyer use the same ISP and is therefore impractical in the currently fragmented market for ISP's.

In online auction houses such as eBay, individuals buy from one another, and any two individuals generally make only one transaction between them. Most individual sellers are not set up to take credit cards. Even if they were, the benefits of using credit cards for such purchases (often only $5-10 per purchase) would not be worth the processing fees, and many buyers would be leery of providing such sensitive information to complete strangers. Therefore, the most common forms of payment are money orders or cashiers' checks and personal checks. Obtaining a money order or cashier's check is inconvenient and costly, while the use of a personal check requires the seller to wait for the check to clear.

It is known in the art to provide escrow accounts for individuals wishing to do business with one another in online auction houses. However, the use of such accounts imposes its own transaction costs. Moreover, the buyer and seller must subscribe to the same provider of such accounts. Furthermore, when the payment is released to the seller, the seller must still wait for a check to arrive by mail.

In an attempt to overcome the above-noted difficulties, various proposals have been made for electronic cash. The proposals fall into three categories: proprietary pre-paid accounts, billing by IP (Internet protocol) number and smart cards. None have enjoyed much success.

Using a proprietary pre-paid account, a user can access the account with a PIN and spend money from the account at any participating online merchant. However, such an account cannot succeed without a large base of merchants participating with any particular provider of the account.

Billing by IP number seeks to expand the above-noted technique of using an ISP's billing system to situations in which the merchant and the buyer use different ISP's. The merchant recognizes the buyer's ISP by the buyer's IP number and charges the purchase to the buyer's account with that ISP. However, the ISP's used by the merchant and the buyer must subscribe to the same service. Also, the use of the IP number offers openings for fraud and abuse and does not overcome the issue of anonymity.

A user with a smart card can fill the smart card with a desired amount of money and use the card to spend that money at participating merchants. While losses due to fraud are limited to the amount on the card, the merchants must still be set up to accept the smart card, and the card requires a special reader attached to the computer.

### SUMMARY OF THE INVENTION

It will be readily apparent from the above discussion that a need exists in the art for an online payment system which brings the conveniences of cash in terms of wide acceptance, wide availability, anonymity, utility for small purchases and limited susceptibility to fraud to e-commerce.

It is therefore an object of the present invention to provide a type of electronic cash which uses existing payment infrastructures rather than a proprietary payment system or a separate billing contract with each ISP.

It is a further object of the invention to provide a type of electronic cash for persons who, for whatever reasons, do not have credit cards.

It is a still further object of the invention to provide a type of electronic cash which can be used anonymously.

It is another object of the invention to provide a type of electronic cash which can be used for small purchases, particularly between individuals.

It is yet another object of the invention to provide a type of electronic cash whose susceptibility to fraud is limited to an amount predetermined by the user.

To achieve the above and other objects, the present invention is directed to the issuance of pre-paid, anonymous debit cards usable with an established network of credit cards, e.g., MasterCard or Visa. The issuer contracts with a card-issuing bank to provide a main account divided into multiple sub-accounts. When a user wants a card, the user prepays the issuer, which provides the user with a card on one of the sub-accounts. The card has a positive balance equal to the amount which the user has pre-paid to the issuer, minus a service charge.

If the card is to be used for online purchases, it can be issued instantly simply by generating a number and providing the number to the user in a sufficiently secure manner. Since online merchants never see a physical credit card, no such physical card is needed.

The issued card bears the name of the issuer and is therefore anonymous as far as the user is concerned, while satisfying merchant banks' requirement for a name on the card. Also, for further privacy, the user can elect to have purchases disassociated with the sub-account and associated only with the main account. Since merchants are paid out of the main account, such disassociation is of no concern either to merchants or to the card-issuing bank.

However, if the user so elects, the user runs risks such as loss of the value on the card if the card itself is lost and inability to dispute purchases with merchants. Whether such risks are acceptable is, of course, a decision for each user.

If a thief obtains the card number, the thief can use the card only to the value which the user has placed on the card. Therefore, the user can predetermine the maximum fraud loss.

In an electronic auction house, the buyer can pay the seller by causing such a card to be issued to the seller. The seller can then either redeem the value of the card at a financial institution honoring that type of card or use it to make purchases online.

The card can also be given as a gift. The giver can elect to give a card which is usable at any online merchant which accepts the corresponding type of credit card or to restrict the card to certain online merchants or to certain types of goods. The giver can also elect to have the card restricted in other ways, e.g., by obtaining a card which cannot be cashed in. Such restrictions are especially useful if the recipient is a minor.

Throughout the present disclosure, the word “customer” will refer to the purchaser of the electronic debit card. The word “holder” will refer to a person holding the card and may be the customer or a person to whom the customer has given the card, either as a gift or in payment for a purchase.

### BRIEF DESCRIPTION OF THE DRAWINGS

A preferred embodiment of the present invention will be set forth in detail with reference to the drawings, in which:

FIG. 1 shows an overview of the interactions among four entities involved with the electronic debit card according to the preferred embodiment;

FIG. 2 shows a Web page for purchasing an electronic debit card for one's self;

FIG. 3 shows a Web page in which the electronic debit card is provided to the customer;

FIG. 4 shows a Web page for purchasing an electronic debit card for another;

FIG. 5 shows a Web page in which the electronic debit card is provided to the recipient;

FIG. 6 shows a Web page for checking a balance and a purchase history for an electronic debit card;

FIG. 7 shows a Web page for choosing whether to roll over or redeem an electronic debit card;

FIG. 8 shows a Web page for rolling over an electronic debit card;

FIG. 9 shows a Web page for redeeming an electronic debit card; and

FIG. 10 shows a hardware setup for issuing, maintaining and using the electronic debit card.

### DETAILED DESCRIPTION OF THE PREFERRED EMBODIMENT

A preferred embodiment of the present invention will now be set forth in detail with reference to the drawings, in which like reference numerals identify like components or operational steps throughout.

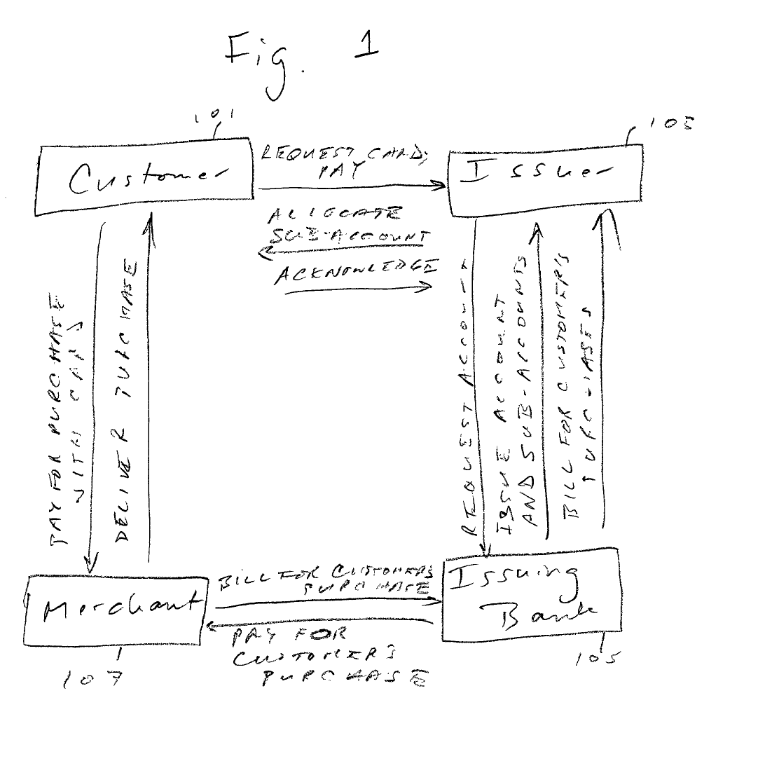

FIG. 1 shows an overview of the interactions among four entities involved with the electronic cash according to the preferred embodiment: the customer 101, the issuer 103, the issuing bank 105 and the merchant 107. The issuing bank is a bank or other financial institution which participates in an existing network of credit cards such as MasterCard or Visa. The issuer of the electronic cash contracts with the issuing bank for an account. The loot issuing bank provides a main account whose terms are between the issuer and the issuing bank. The main account is divided into sub-accounts which the issuer is free to reissue, although the issuer is ultimately responsible to the issuing bank for their use. The main account and the sub-accounts are all issued in the name of the issuer.

The customer requests an electronic debit card from the issuer and pays the issuer for the card (for example, $80 for a card having a pre-paid value of $75 with a $5 service charge). The issuer allocates a sub-account to the customer and issues a card having the $75 pre-paid value and bearing the name of the issuer. The customer acknowledges receipt of the card, upon which the card becomes active. The last-named step is similar to the acknowledgment and activation of conventional credit cards sent through the mail. The customer is then free to use the card at the merchant. The customer pays for the merchant by providing the merchant with the card number, the expiration date and the name on the card. The merchant delivers the purchase to the customer, e.g., by shipping a physical item, permitting a download of software or providing a password to access a Web site.

Since the name on the card is that of the issuer, the customer's purchase is anonymous. Also, since the card cannot be used for a purchase greater than the amount placed on the card (in the present example, $75) minus whatever purchases have already been made on the card, a credit-card thief who intercepts the communication between the customer and the merchant can abuse the card only for a small amount. By contrast, with a conventional credit card, the thief could charge thousands or tens of thousands of dollars to the customer's account.

The merchant bills the purchase to the issuing bank, which pays the merchant and bills the main account. The process is the same as that for the corresponding type of conventional credit card, thus ensuring wide acceptance for the electronic debit card. The issuer pays the issuing bank's bill with the money paid into the sub-accounts by customers.

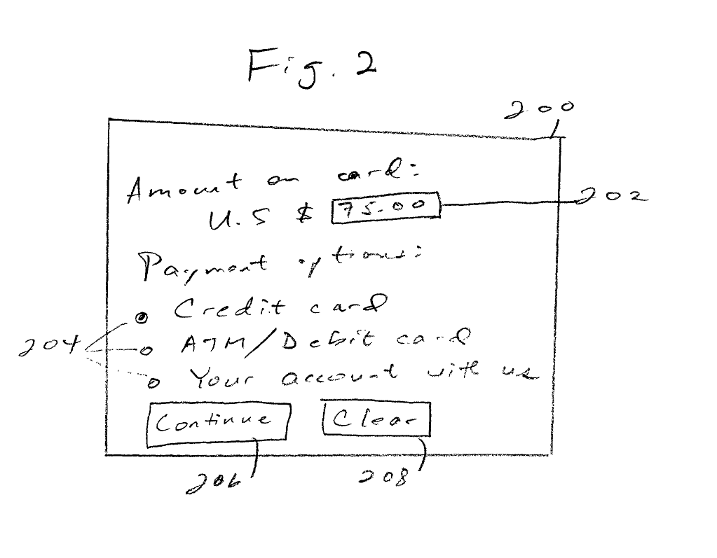

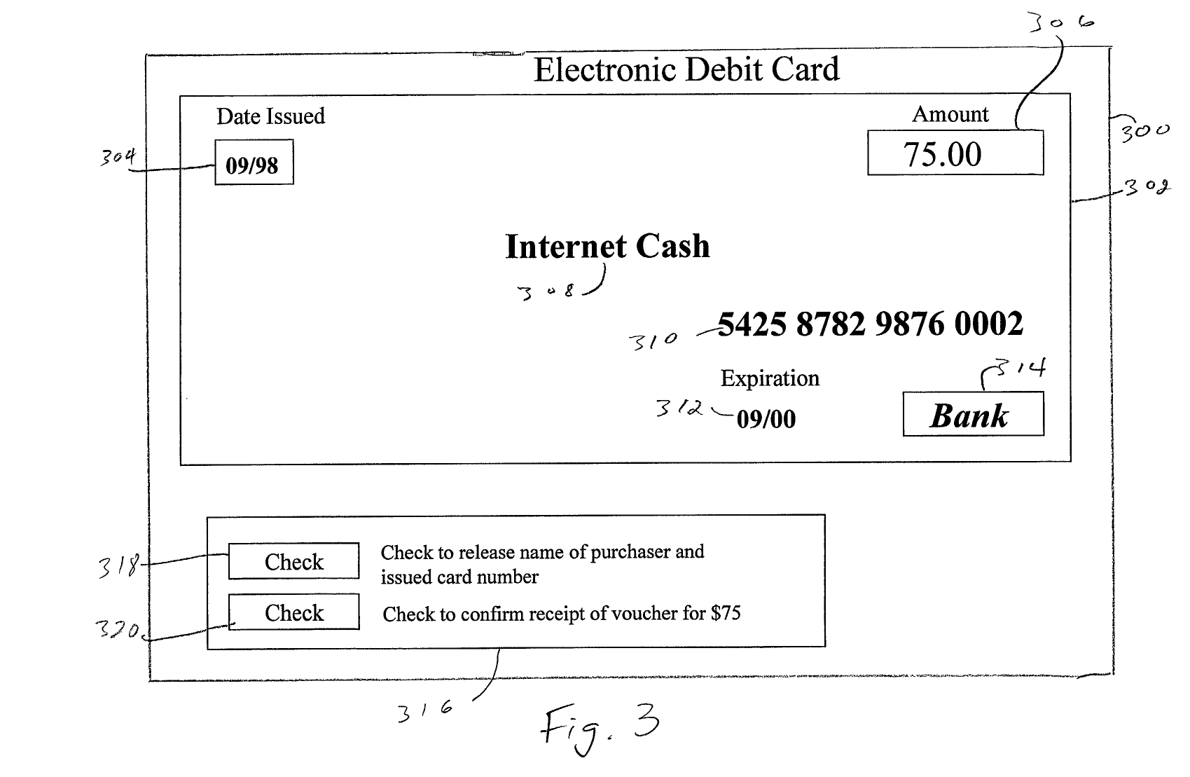

The customer obtains a card from the issuer in the following manner. The customer communicates with the issuer, e.g., by accessing the issuer's Web site, and is presented with a page 200 such as that shown in FIG. 2. The page 200 includes a text box 202 into which the customer types the amount to be placed on the card and radio buttons 204 to select how the card is to be paid for. The card may be paid for by credit card or ATM/debit card, in which case the customer will be prompted for further information. Paying by credit card or ATM/debit card does not defeat the anti-fraud feature noted above, since the electronic debit card to be issued is not automatically refilled once its value is depleted. In fact, the information about the credit or ATM/debit card used to pay for the electronic debit card can be erased from the system once the electronic debit card is issued. The customer can also establish a pre-payment account with the issuer, which is separate from the main account between the issuer and the issuing bank. If so, the customer can instruct the issuer to debit whatever amount is due from that pre-payment account. Whatever payment option is selected, the customer clicks on the “Continue” button 206 or the “Clear” button 208.

Once the customer has proceeded as just described and entered all pertinent payment information, the customer sees a page 300 such as that shown in FIG. 3. The upper portion of the page 300 includes a representation 302 of the electronic debit card. The representation 302 includes a date of issuance 304, an amount 306, the issuer's name 308, the card number 310, the expiration date 312 and the logo 314 of the issuing bank. The lower portion includes an activation area 316 having two check boxes 318 and 320. The first check box 318 gives the customer the option of releasing, or disassociating, the name of the customer and the issued card number. With that option, records on purchases made with the electronic debit card reflect only the issuer's identity, not the customer's. As far as the merchant or the issuing bank is concerned, the customer does not exist. Thus, anonymity is assured. The down side is that the customer cannot contest transactions made with the card or retrieve the value of a lost card. The customer checks the second check box 320 to confirm receipt of the electronic debit card and thereby to activate it.

The customer uses the electronic debit card in the following manner. The customer prints the page 300 or otherwise retains a record of the representation 302 and keeps the record in a safe place. When a merchant prompts the customer for credit-card information, the customer enters the number 310 as the card number, the expiration date 312 as the card expiration date and the issuer's name 308 as the cardholder's name. A physical card is not 15t normally issued, since the existence or nonexistence of such a physical card is irrelevant to online merchants. However, for an additional charge, the issuer could issue such a physical card to the customer. As described above, the merchant processes the transaction and bills the issuing bank as though the electronic debit card were any other kind of credit or debit card.

The customer can alternatively elect to have an electronic debit card e-mailed to someone else. Two reasons to do so are to pay another individual for a purchase made through an online auction house and to give the value on the electronic debit card as a gift.

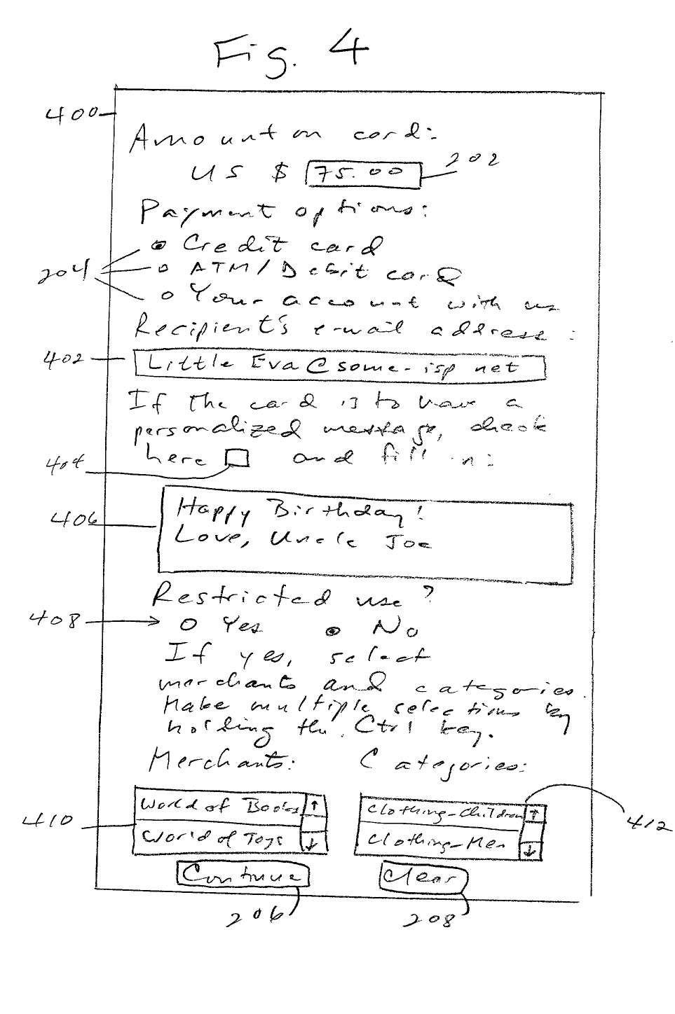

To send a card, the customer accesses the issuer's Web site and follows a link to a page 400 such as that shown in FIG. 4. The page 400 is like the page 200 of FIG. 2, except with the following additions. The customer enters the recipient's e-mail address into a text box 402. If the card is to be personalized, the customer checks a check box 404 and enters a message into a text box 406. The message can be a greeting for a gift certificate or can identify the item purchased in an online auction. The customer is also offered the option of restricting the use of the card through a pair of radio buttons 408. The “No” button is selected by default, in which case the recipient can use the card at any merchant which accepts the corresponding type of credit card or simply redeem the value on the card. If the customer selects “Yes,” the customer can select acceptable merchants through a scroll box 410, acceptable categories of items to be purchased through a scroll box 412 or both. A card thus restricted is usable only in accordance with the restrictions and cannot be redeemed or rolled over for its value.

The recipient can retrieve the card in any of several ways which will be readily apparent to those skilled in the art who have reviewed the present disclosure. One such way will now be set forth. The issuer sends the recipient an e-mail message such as the following:

“Dear LittleEva@some-isp.net: You have been sent an electronic debit card for $75.00 from JoeBob@another-isp.com. To access it, please go to the following URL . . . ”

When the recipient follows the link, the recipient sees a page 500 such as that shown in FIG. 5. The page 500 shows a representation of an electronic debit card similar to that of FIG. 3, with the following differences. The name 502 on the card can optionally be different from the name 308 in FIG. 3. The personalized message typed into the text box 406 appears at 504. If the card is restricted, a code or codes 506 identify the restriction. The recipient can be provided with a list of codes to determine where the card is valid.

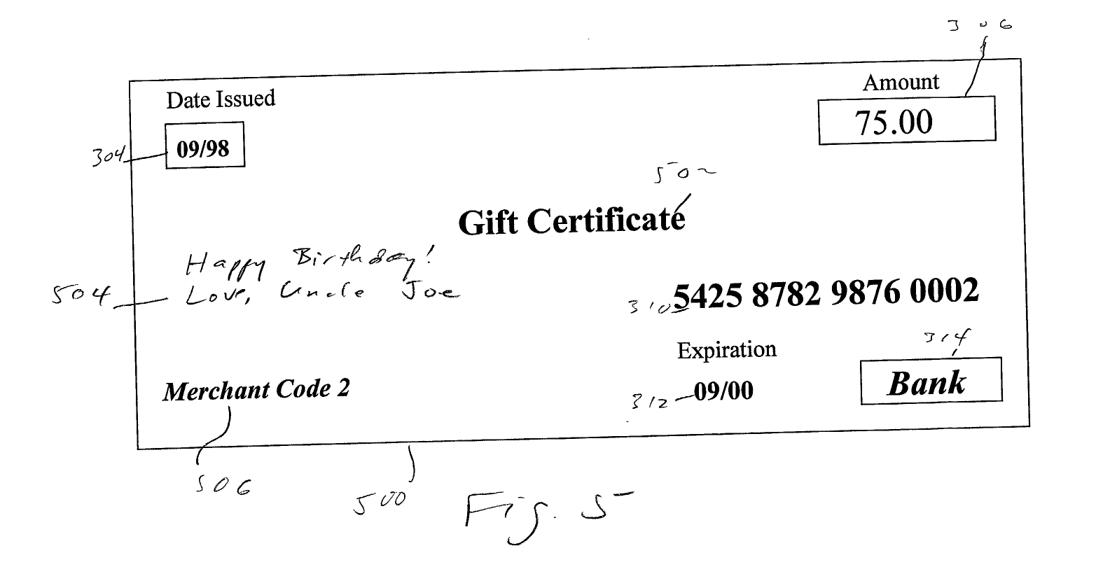

The holder can access the issuer's Web site and check the present balance or the purchase history through a page 600 such as that shown in FIG. 6. The holder enters the card number into a text box 602 and clicks on a button 604 to check the present balance or a button 606 to check the purchase history. If the customer when purchasing the card elected to release the name, the button 606 will return an error message stating so.

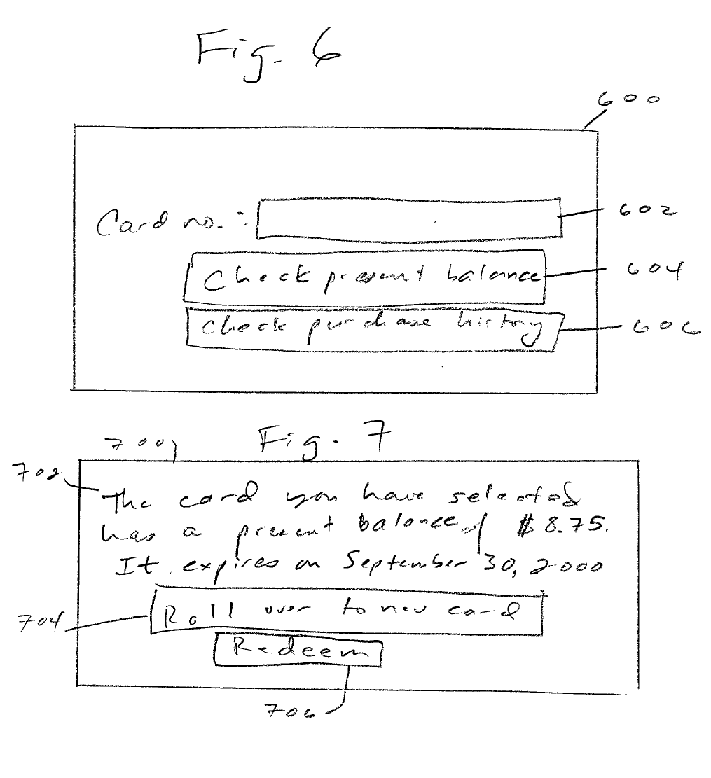

Clicking on the button 604 results in a page 700 such as that shown in FIG. 7. The page 700 includes a message stating the current balance on the card and the expiration date. The holder is given the option of rolling the balance over to a new card by clicking on a button 704 or redeeming the balance by clicking on a button 706.

Any electronic debit card, except those which have been restricted, can be redeemed or cashed in, or can be rolled over onto another card. The holder may wish to do so when the card is about to expire or when the card has too little value left on it to do anything useful.

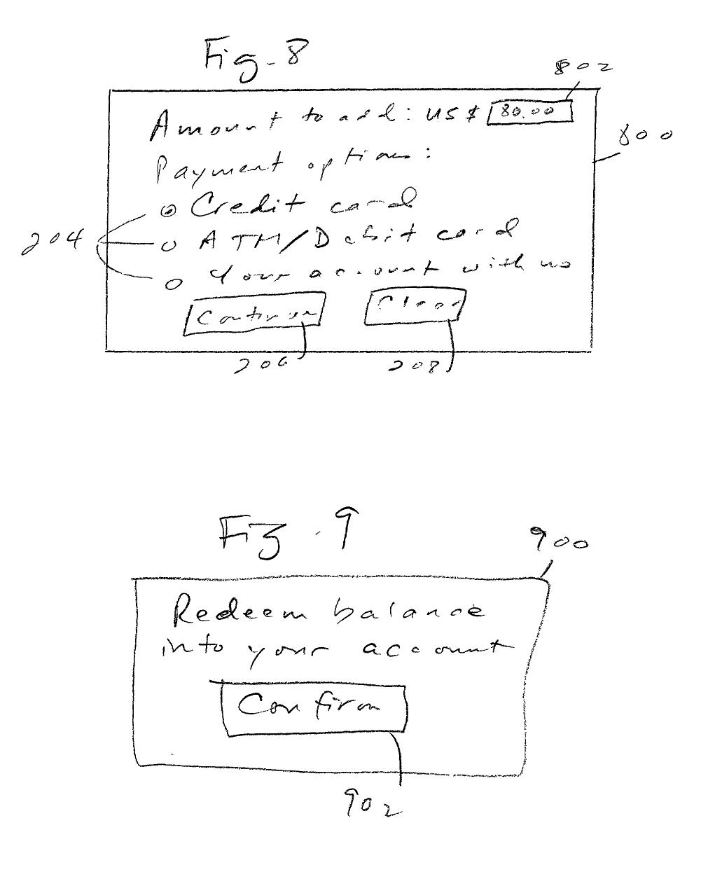

Clicking on the button 704 results in a page 800 such as that shown in FIG. 8. The page 800 is like the page 200 of FIG. 2, except that a text box 802 prompts for an amount to be added to the card. The process is similar to that for rolling over value on fare cards in some transit systems.

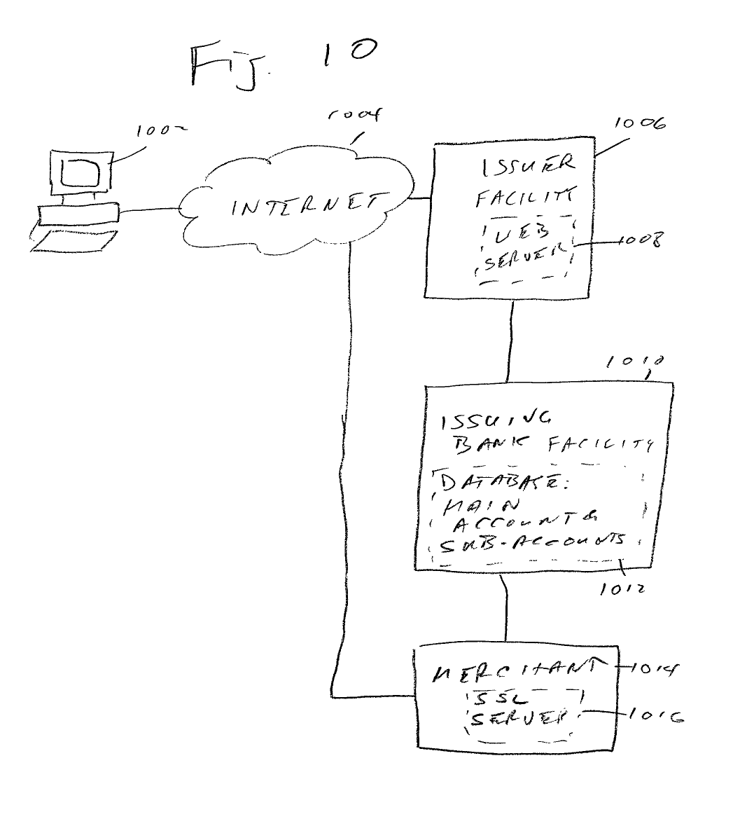

Clicking on the button 806 results in a page 900 such as that shown in FIG. 9. The holder, if a customer with an account, can click on a button 902 to credit the amount on the card to the account.

The electronic debit card is issued, maintained and used in a hardware setup such as that shown in FIG. 10. The customer uses a microcomputer 1002 or other device for accessing the Internet 1004. The issuer maintains an issuer facility 1006 which communicates with the customer through a Web server 1008 connected to the Internet 1004. The issuer facility 1006 accepts the pre-payment from the customer, maintains the customer's pre-payment account if any and allocates a sub-account and an associated card number. The Web server 1008 generates whatever Web pages are needed to communicate with the customer to accomplish those tasks, including the Web pages of FIGS. 2-9.

The issuer facility 1006 communicates with an issuing bank facility 1010 over a dedicated line or the like. The issuing bank facility 1010 includes a database 1012 for maintaining account information on the main account and on each sub-account in accordance with information received from the issuer facility 1006 and transaction information received from merchants. The issuing bank facility 1010 is similar to existing computer facilities used by banks for maintaining account information on credit cards and clearing transactions made with those credit cards, but has the additional ability to maintain whatever information on each sub-account is required to clear transactions made on the corresponding electronic debit card. Also, when the issuer facility 1006 receives a balance query from the customer, the issuer facility 1006 can pass the query to the issuing bank facility 1010, which sends information on the account balance back to the issuer facility 1006.

The issuing bank facility 1010 communicates with merchants 1014 to clear the transactions. Each merchant has some ability to receive card information from buyers, such as a secure socket layer (SSL) server 1016. The merchant communicates with the customer's computer 1002 over the Internet 1004. Communications between the merchant 1014 and both the issuing bank facility 1010 and the customer's computer 1002 can be accomplished in ways known in the art of credit-card processing. Of course, the communication between the merchant 1014 and the issuing bank facility 1010 could be accomplished indirectly, e.g., through the merchant's bank.

Security features can be added. For example, the customer, when purchasing the card, can elect to have a PIN associated with the card. Similarly, a card sent to a recipient can have a PIN associated with it so that the recipient can activate the card only with the PIN. Such a feature can be useful, e.g., if the card is to be used in place of an escrow account; in that case, the customer can instruct the issuer to send the PIN upon approval, or the issuer can send the PIN automatically if the customer lets the approval period lapse.

While a preferred embodiment of the present invention has been set forth in detail above, those skilled in the art who have reviewed the present disclosure will readily appreciate that other embodiments can be realized within the scope of the present invention. For example, the functions of the issuer and the issuing bank can be performed by a single entity. Also, the customer can buy the electronic debit card with a check, in which case the issuer notifies the customer that the card has been issued in a manner similar to notification of the gift card. Therefore, the present invention should be construed as limited only by the appended claims.

We claim:

1. A method for providing an electronic debit card which is compatible with an existing network of credit cards, the method comprising:
(a) providing, through a financial institution which participates in the existing network of credit cards, a main account divided into a plurality of sub-accounts, purchases made on each of the plurality of sub-accounts being payable out of the main account through the existing network of credit cards;
(b) receiving a pre-payment from a customer;
(c) providing one of the plurality of sub-accounts with a credit balance not exceeding the amount of the pre-payment to form a pre-paid sub-account; and
(d) making the pre-paid sub-account available to a user who is one of (i) the customer and (ii) a third party designated by the customer by issuing the electronic debit card to access the pre-paid sub-account.

2. The method of claim 1, wherein step (b) is performed over the Internet.

3. The method of claim 1, wherein step (d) comprises providing the user with a notification over the Internet of a card number and expiration date of the electronic debit card.

4. The method of claim 1, wherein step (d) comprises issuing the electronic debit card in a name other than a name of the user.

5. The method of claim 1, wherein step (d) comprises permitting the customer to choose whether records of purchases made on the electronic debit card shall be associated with the pre-paid sub-account or solely with the main account.

6. The method of claim 1, further comprising:
(e) receiving a query from the user of an outstanding balance on the electronic debit card; and
(f) reporting the outstanding balance to the user in accordance with the query.

7. The method of claim 6, further comprising:
(g) receiving an additional pre-payment and a command to roll over the outstanding balance; and
(h) issuing an additional electronic debit card having a credit balance not greater than the sum of the outstanding balance and the additional pre-payment.

8. The method of claim 1, wherein step (b) comprises deducting the pre-payment from a pre-payment account maintained by the customer.

9. The method of claim 8, further comprising:
(i) receiving a command from the customer to redeem an outstanding balance on the electronic debit card; and
(j) depositing the outstanding balance into the pre-payment account in accordance with the command received in step (i).

10. The method of claim 1, wherein the electronic debit card is issued to the third party, and wherein step (d) comprises:
(A) receiving from the customer a command to restrict use of the electronic debit card by merchant, by type of merchandise or both; and
(B) issuing the electronic debit card so as to be payable only in accordance with the command.

11. A method for obtaining an electronic debit card which is compatible with an existing network of credit cards, the method comprising:
(a) making a pre-payment into a sub-account which is one of a plurality of sub-accounts into which a main account is divided, purchases on each of the plurality of sub-accounts being payable out of the main account through the existing network of credit cards, to form a pre-paid sub-account;
(b) causing the electronic debit card to be issued to a user to access the pre-paid sub-account.

12. The method of claim 11, wherein step (a) is performed over the Internet.

13. The method of claim 11, wherein step (b) comprises providing the user with a notification over the Internet of a card number and expiration date of the electronic debit card.

14. The method of claim 11, wherein step (b) comprises issuing the electronic debit card in a name other than a name of the user.

15. The method of claim 11, wherein step (b) comprises choosing whether records of purchases made on the electronic debit card shall be associated with the pre-paid sub-account or solely with the main account.

16. The method of claim 11, further comprising:
(c) making a query of an outstanding balance on the electronic debit card; and
(d) receiving a report of the outstanding balance in accordance with the query.

17. The method of claim 16, further comprising:
(e) making an additional pre-payment and a command to roll over the outstanding balance; and
(f) receiving an additional electronic debit card having a credit balance not greater than the sum of the outstanding balance and the additional pre-payment.

18. The method of claim 11, wherein step (a) comprises:
(A) maintaining a pre-payment account; and
(B) causing the pre-payment to be deducted from the pre-payment account.

19. The method of claim 18, further comprising:
(g) issuing a command to redeem an outstanding balance on the electronic debit card; and
(h) receiving the outstanding balance into the pre-payment account in accordance with the command received in step (g).

20. The method of claim 11, wherein the user is a person different from a person who makes the pre-payment in step (a), and wherein step (b) comprises:
(A) issuing a command to restrict use of the electronic debit card by merchant, by type of merchandise or both; and
(B) causing the electronic debit card to be issued so as to be payable only in accordance with the command.

21. A system for providing an electronic debit card which is compatible with an existing network of credit cards, the method comprising:
(a) an issuing bank facility for providing, through a financial institution which participates in the existing network of credit cards, a main account divided into a plurality of sub-accounts, purchases made on each of the plurality of sub-accounts being payable out of the main account through the existing network of credit cards; and
(b) an issuer facility, in communication with the issuing bank facility and with a customer, for receiving a pre-payment from the customer, providing one of the plurality of sub-accounts with a credit balance not exceeding the amount of the pre-payment to form a pre-paid sub-account, and making the pre-paid sub-account available to a user who is one of (i) the customer and (ii) a third party designated by the customer by issuing the electronic debit card to access the pre-paid sub-account.

22. The system of claim 21, wherein the issuer facility receives the pre-payment over the Internet.

23. The system of claim 21, wherein the issuer facility provides the user with a notification over the Internet of a card number and expiration date of the electronic debit card.

24. The system of claim 21, wherein the issuer facility issues the electronic debit card in a name other than a name of the user.

25. The system of claim 21, wherein the issuer facility permits the customer to choose whether records of purchases made on the electronic debit card shall be associated with the pre-paid sub-account or solely with the main account.

26. The system of claim 21, wherein the issuing facility receives a query from the user of an outstanding balance on the electronic debit card and reports the outstanding balance to the user in accordance with the query.

27. The system of claim 26, wherein the issuing facility receives an additional pre-payment and a command to roll over the outstanding balance and issues an additional electronic debit card having a credit balance not greater than the sum of the outstanding balance and the additional pre-payment.

28. The system of claim 21, wherein the pre-payment is deducted from a pre-payment account maintained by the customer.

29. The system of claim 28, wherein, when the customer issues a command to the issuing facility to redeem an outstanding balance on the electronic debit card, the issuing facility deposits the outstanding balance into the pre-payment account in accordance with the command.

30. The system of claim 21, wherein the electronic debit card is issued to the third party, and when the customer issues a command to restrict use of the electronic debit card by merchant, by type of merchandise or both, the issuing facility issues the electronic debit card so as to be payable only in accordance with the command.
